(19) United States
(12) Patent Application Publication
(10) Pub. No.: US 2020/0243841 A1
(43) Pub. Date: Jul. 30, 2020

(54) ANODES, METHODS FOR PREPARING THE SAME, AND LITHIUM ION BATTERIES

(71) Applicant: Microvast Power Systems Co., LTD., Huzhou City, Zhejiang Province (CN)

(72) Inventors: SHENGCHEN YANG, Huzhou City, Zhejiang Province (CN); KAIQIANG WU, Huzhou City, Zhejiang Province (CN); ZHUOQUN ZHENG, Huzhou City, Zhejiang Province (CN); XIANG LI, Huzhou City, Zhejiang Province (CN); SUMIHITO ISHIDA, Huzhou City, Zhejiang Province (CN); WENJUAN LIU MATTIS, Huzhou City, Zhejiang Province (CN)

(21) Appl. No.: 16/639,558

(22) PCT Filed: Aug. 17, 2017
(86) PCT No.: PCT/CN2017/097851

§ 371 Date: Feb. 14, 2020

(51) Int. Cl. H01M 4/133; H01M 4/587; H01M 4/62; H01M 4/04; H01M 4/1393; H01M 10/0525

(52) U.S. Cl. CPC H01M 4/133; H01M 4/587; H01M 4/622; H01M 4/625; H01M 2004/021; H01M 4/0471; H01M 4/1393; H01M 10/0525; H01M 4/0404

(57) ABSTRACT

An anode, which includes a current collector and an anode material stack coated on the current collector, the anode material stack includes an anode active material layer, which includes porous carbon material and a first binder, and the porous carbon material is mixed with the binder. The anode material stack further includes a carbon intermediate layer sandwiched between the current collector and the anode active material layer. It also provides a method for preparing the anode. Further, it provides a lithium ion battery including the anode above.

### FIELD OF THE INVENTION

The present disclosure relates to anodes used in lithium secondary batteries, methods for preparing the same, and lithium ion batteries including such anodes.

### BACKGROUND OF THE INVENTION

Compared with conventional lead-acid batteries or nickel-metal hydride (NiMH) batteries, lithium ion secondary batteries have higher energy density. Because of this, they have been widely used as power sources of portable electronic equipment such as mobile phones, digital cameras, and notebook computers. In recent years, energy savings and environment protection have seen increased emphasis. As a clean and environmental-friendly energy source, lithium ion batteries have found commercial applications in hybrid electric vehicles (HEV), battery electric vehicles (BEV), and energy storage for the solar power generation and wind power generation industries, among other things. However, further technical development in such fields will require increased battery capacity and longer life-span.

Conventionally, lithium metal oxides, for example, lithium cobalt oxide (LiCoO₂), lithium manganate (LiMn₂O₄), lithium nickelate (LiNiO₂) or lithium iron phosphate (LiFePO₄), have been applied as cathode active materials of lithium ion secondary batteries.

With regard to the anode material, although Si and Sn alloys have been subject to significant research, such alloys have not been put into commercial use due to certain disadvantages including expansion limitation, poor conductivity and low charge-discharge efficiency. Meanwhile, lithium metal or lithium-containing alloys have been considered as anode active materials with high energy density. During charging, a reduction reaction takes place and lithium metal is produced; when discharging, lithium metal is oxidized to lithium ions.

However, such lithium metal or lithium-containing alloys also have their disadvantages when used in batteries. First, during charging, the lithium metal produced crystallizes to form small lithium particles or lithium dendrites on the anode. Such small lithium particles or lithium dendrites mainly accumulate on surfaces of anodes, which rapidly decreases the life-span of the batteries. Second, when accumulated to a certain extent, lithium dendrites would puncture the lithium battery separator, which leads to short circuiting of the batteries and safety risks. Third, such small lithium particles have high specific surface area and also have high activity, especially under high temperature, which also lead to safety risks. Fourth, along with the process of oxidation-reduction reactions of lithium ions, lithium metal deposits on the anodes, and this would increase the thickness of the anode. Fifth, the lithium metal that deposits on the anode surface tends to detach from the anode surface. When the lithium metal becomes detached, as a result, it is no longer involved in charging or discharging process, which shortens the life-span of batteries. Sixth, if the electrodes are covered by a ceramic solid electrolyte, the solid electrolyte will expand/contract when charging/discharging due to the precipitation of lithium. Such expansion/contraction leads to cracks appearing in the solid electrolyte when there are external vibrations, and such cracks impede the movement of lithium ions and disables the batteries. All the disadvantages above cause safety risks in batteries.

In order to make the oxidation-reduction reaction of the lithium metal reversible and solve the safety problems noted above, significant research has been conducted on thin-film laminated batteries and actual applications, wherein lithium metal deposits on current collectors. However, the preparation of such thin-film laminated batteries requires vacuum evaporation equipment, the use of which leads to poor production efficiency and high manufacturing cost of batteries. Meanwhile, the thin-film laminated batteries also need more laminated layers, more separators as well as more current collectors, all of which leads inevitabley to decreases in energy density. Therefore, the thin-film laminated batteries could not solve the safety problem.

In view of the above, it is desirable to provide anodes which could endow the batteries with higher capacity, higher energy density and longer life-span, and it is also desirable to provide batteries that include such anodes.

### SUMMARY OF THE INVENTION

The present disclosure provides an anode, which includes a current collector and an anode material stack coated on the current collector, the anode material stack includes an anode active material layer, the anode active material layer includes porous carbon material and a first binder, and the porous carbon material is mixed with the binder.

In one embodiment, the first binder is selected from the following: polyvinyl alcohol, carboxymethyl cellulose, hydroxypropyl cellulose, polyvinyl chloride, carboxylic polyvinyl chloride, polyvinyl fluoride, ethylene oxide polymer, polyvinylpyrrolidone, polyurethane, polytetrafluoroethylene, polyvinylidene fluoride, polyethylene, polypropylene, styrene-butadiene rubber, acrylate butadiene rubber, epoxy resin or nylon.

In one embodiment, the porous carbon material is amorphous structured, and includes a plurality of meso-pores and micro-pores, a pore diameter of the meso-pores is 2-50 nm, and that of the micro-pores is less than 2 nm.

In one embodiment, the porous carbon material is hard carbon dotted with pores, and a volume of the pores accounts for 20%˜50% of the whole volume thereof; in another embodiment, the porous carbon material is a soft carbon synthesized by pitches.

In yet another embodiment, the porous carbon material is selected from carbon black, charcoal, coke, bone black, sugar charcoal, activated carbon and cellulose carbon.

In one embodiment, a porosity of the porous carbon material is in a range from 5% to 50%.

In another embodiment, the porous carbon material is in a form of active powders, and an electrical conductivity thereof is in a range from 10⁻² S/cm to 10³ S/cm.

In one embodiment, the anode material stack also includes a carbon intermediate layer. The carbon intermediate layer is sandwiched between the current collector and the anode active material layer, and the carbon intermediate layer includes a second carbon material and a second binder. The second carbon material is mixed with the second binder.

In one embodiment, a material of the second binder is different from that of the first binder, which is selected from a group consisting of but not limited to the following: polyvinyl alcohol, carboxymethyl cellulose, hydroxypropyl cellulose, polyvinyl chloride, carboxylic polyvinyl chloride, polyvinyl fluoride, ethylene oxide polymer, polyvinylpyrrolidone, polyurethane, polytetrafluoroethylene, polyvinylidene fluoride, polyethylene, polypropylene, styrene-butadiene rubber, acrylate butadiene rubber, epoxy resin or nylon.

In one embodiment, the carbon intermediate layer is made of conductive carbon material, and the electrical conductivity of the conductive carbon material is higher than that of the porous carbon material.

In one embodiment, the anode active material layer and/or the carbon intermediate layer further include a conductive material therein, which is selected from the following: natural graphite, artificial graphite, carbon black, acetylene black, conductive carbon black, carbon fiber; metal powder or metal fiber of copper, nickel, aluminum or silver; polyphenyl derivatives, or a mixture of the above.

In one embodiment, the anode material stack has a density at a range from 0.5 g/cc to 1.0 g/cc.

The present disclosure further provides a method for preparing the anode that includes the following steps: providing a current collector; mixing a porous carbon material and a first binder with a solvent to form an anode active material mixture, wherein the solvent is N-methylpyrrolidone; coating the anode active material mixture onto the current collector to form an anode active material layer; and drying and rolling to yield the anode.

In one embodiment, the method further includes the following steps: mixing a second carbon material and a second binder with a solvent to form a carbon intermediate mixture; before coating the anode active material mixture, coating the carbon intermediate mixture onto the current collector to form the carbon intermediate layer; and then coating the anode active material mixture onto the carbon intermediate layer.

The present disclosure also provides a lithium ion battery, which includes an anode, a cathode, and a separator sandwiched between the anode and the cathode, and an electrolyte immersing the anode and the cathode; the anode is as described above.

The anode described above can give the batteries higher capacity, higher energy density and longer life-span. In such batteries, when lithium metal deposits on the anode, in the presence of the porous carbon material of the anode, expansion/contraction of the anode is reduced. Further, in the presence of the porous carbon material on the current collector of the anode, during charging, small lithium particles or lithium dendrites would never form on the anode surface, and detached lithium metal would not be produced. As a result, the battery capacity does not decrease. Therefore, the batteries of the present disclosure have higher capacity, higher energy density and longer life-span.

The anode of the present disclosure is a thick-film electrode produced by conventional coating equipment, instead of a thin-film electrode produced by CVD (chemical vapor deposition) or PVD (Physical vapor deposition).

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. These descriptions are not intended to be exhaustive nor to limit the invention to the precise forms disclosed.

The present disclosure provides an anode, which includes a current collector and an anode material stack; the anode material stack is coated on the current collector. In one embodiment, the current collector is a thin-film current collector. In another embodiment, the current collector of the anode is mainly composed of transition metals. In yet another embodiment, the current collector is made of copper foil.

In one embodiment, the anode material stack includes an anode active material layer, which is coated on the current collector. In one embodiment, the anode active material layer which is coated on the current collector includes porous carbon material and a first binder, wherein the porous carbon material is mixed with the binder uniformly. In another embodiment, the porous carbon material includes a plurality of pores therein and has an amorphous structure.

In one embodiment, the first binder functions to cause the porous carbon material to adhere onto the current collector or other layer, and simultaneously functions to cause the porous carbons to adhere together to form a layer. In one embodiment, the first binder is selected from a group consisting of but not limited to the following: polyvinyl alcohol (PVA), carboxymethyl cellulose (CMC), hydroxypropyl cellulose (HPC), polyvinyl chloride (PVC), carboxylic polyvinyl chloride, polyvinyl fluoride (PVF), ethylene oxide polymer, polyvinylpyrrolidone (PVP), polyurethane (PU), polytetrafluoroethylene (PTFE), polyvinylidene fluoride (PVDF), polyethylene (PE), polypropylene (PP), styrene-butadiene rubber (SBR), acrylate butadiene rubber, epoxy resin or nylon etc..

In one embodiment, the porous carbon material includes a plurality of meso-pores and micro-pores, wherein a pore diameter of the meso-pores is 2-50 nm, and that of the micro-pores is less than 2 nm.

In one embodiment, the porous carbon material is hard carbon (i.e., non-graphitizable carbon), which is dotted with pores. The volume of the pores accounts for 20%˜50% of the whole volume thereof. Meanwhile, the hard carbon is selected from carbon black, charcoal, coke, bone black, sugar charcoal, activated carbon and cellulose carbon. For example, the porous carbon material in the present application can be a carbon material trademarked as “Carbotron® P” produced by Kureha Group, which is made from pseudo isotropic carbon. For another example, the porous carbon material can be a carbon molecular sieve produced by Kuraray Corporation. In another embodiment, the porous carbon material is soft carbon (i.e., graphitizable carbon), which is synthesized by pitches etc..

When the battery is charging, a reduction reaction would occur and lithium metals would be produced. In one embodiment, the porosity of the porous carbon material is preferably in a range from 5% to 50%. Under such porosity range, lithium metals produced in the oxidation-reduction reaction tend to be contained in the pores of the porous carbons, instead of accumulating on the anode surface. Because of this, the anodes do not expand in volume; then an increase in the thickness of the battery is further avoided. However, if the porosity thereof is lower than 5%, the produced lithium metals would mainly deposit on the surface of the anode active material layer. If it is going on like this, the anode would expand in volume, and the life-span of the battery is therefore reduced. If the porosity of the porous carbon material is higher than 50%, the anode active material layer with amorphous structure would become fragile, and the surface thereof would be inclined to be oxidized therefore introducing oxygen atoms. In the presence of oxygen atoms, an irreversible reaction between the functional oxygen group and lithium metal can easily occur, which would weaken the charge-discharge efficiency.

In one embodiment, the porous carbon material in the anode active material layer is in a form of active powders, and the electrical conductivity of the active powders is in a range from 10⁻² S/cm to 10³ S/cm. It is known that the electrical conductivity of the current collectors is much higher; for example, the electrical conductivity of copper is 5.9×10⁷ S/m, and the electrical conductivity of aluminum is two-thirds of that of copper. That is, the electrical conductivity of the active powders, i.e., the active porous carbon, is much lower than that of the current collector. Meanwhile, the electrical conductivity of the active powders is also lower than that of other conductive materials in the battery electrode. Under such circumstances, polarization would occur, which would force the lithium ions to be selectively detached and accumulate within the porous carbon material or on the surface thereof.

In another embodiment of the present disclosure, the anode includes a current collector, a carbon intermediate layer and an anode active material layer, and the carbon intermediate layer is sandwiched between the current collector and the anode active material layer. The anode active material layer and the carbon intermediate layer together make up the anode material stack. The anode active material layer includes porous carbon material and a first binder, wherein the porous carbon material is mixed uniformly with the first binder. The carbon intermediate layer includes a second binder and a second carbon material, wherein the second carbon material is mixed uniformly with the second binder.

The first binder functions to adhere the porous carbon material together to form the uniform anode active material layer and functions to cause the anode active material layer to adhere to the carbon intermediate layer. In one embodiment, the first binder is selected from a group consisting of but not limited to the following: polyvinyl alcohol (PVA), carboxymethyl cellulose (CMC), hydroxypropyl cellulose (HPC), polyvinyl chloride (PVC), carboxylic polyvinyl chloride, polyvinyl fluoride (PVF), ethylene oxide polymer, polyvinylpyrrolidone (PVP), polyurethane (PU), polytetrafluoroethylene (PTFE), polyvinylidene fluoride (PVDF), polyethylene (PE), polypropylene (PP), styrene-butadiene rubber (SBR), acrylate butadiene rubber, epoxy resin or nylon, etc.

Meanwhile, the second binder functions to cause the second carbon material to adhere together to form the carbon intermediate layer and further functions to cause the carbon intermediate layer to adhere onto the current collector. In one embodiment, the second binder is selected from a group consisting of but not limited to the following: polyvinyl alcohol (PVA), carboxymethyl cellulose (CMC), hydroxypropyl cellulose (HPC), polyvinyl chloride (PVC), carboxylic polyvinyl chloride, polyvinyl fluoride (PVF), ethylene oxide polymer, polyvinylpyrrolidone (PVP), polyurethane (PU), polytetrafluoroethylene (PTFE), polyvinylidene fluoride (PVDF), polyethylene (PE), polypropylene (PP), styrene-butadiene rubber (SBR), acrylate butadiene rubber, epoxy resin or nylon, etc.

Preferably, a material of the second binder is different from that of the first binder. If the first binder and the second binder are the same, the first binder might dissolve the second binder, which leads to instability and non-consistence of the anode active material stack, and affects the life-span of the battery.

The carbon intermediate layer is made of conductive carbon materials which have higher conductivity than the porous carbon material, for example, carbon black or graphite. When the porous carbon material is coated onto the current collector, since the current collector is made of metal, adhesion between the porous carbon material and the metal current collector is weak. The carbon intermediate layer could help the anode active material layer to be coated uniformly. Along this, the adhesion between the anode active material layer and the metal current collector is strengthened, and the life-span of the battery is prolonged.

In one embodiment, the conductive carbon material thereof has an electrical conductivity higher than 10³ S/cm. That is, the electrical conductivity of the conductive carbon intermediate layer is also higher than that of the anode active material layer. In such case, the copper foil acts as the current collector of the anode due to its high conductivity, and the carbon intermediate layer is coated on the copper foil. If the conductivity of the carbon intermediate layer is lower than 10³ S/cm, the surface of the copper foil tends to produce non-uniform lithium metal; such lithium metal tends to detach from the surface, which might lead to the strip off of the anode active material layer.

As mentioned above, the anode active material layer and the carbon intermediate layer make up one anode material stack. In another embodiment, the anode material stack has a density at a range from 0.5 g/cc to 1.0 g/cc. If the density of the anode material stack is higher than 1.0 g/cc, there is not enough room for lithium metal to deposit thereon. Hence, the detached lithium would accumulate on the anode material stack during precipitation, which would force the electrode itself to expand in volume. Such expansion of the anode material stack would increase the physical burden of the electrode, and decrease the life-span of the battery in the long run. If the density of the anode material stack is lower than 0.5 g/cc, pressure applied onto the anode material stack would significantly decrease; and the volumetric efficiency of the anode material stack would correspondingly decrease, which would lead to further capacity reduction of the battery.

The density of the anode material stack above is derived by the following steps: first, the prepared anode is cut into a round piece, wherein a diameter of the round piece can be 5 centimeters; next, the thickness and weight of the round piece is determined, and then the weight and thickness of the current collector are respectively subtracted to get the weight and thickness of the anode material stack, finally yielding the density of the anode material stack.

Optionally, in one embodiment, the anode active material layer and/or the carbon intermediate layer further includes a conductive material therein. The conductive material functions to endow the anode with conductivity. Any conductive material which does not cause chemical change can be used as the conductive material. In one embodiment, the conductive material is selected from the following: carbonaceous materials such as natural graphite, artificial graphite, carbon black, acetylene black, conductive carbon black or carbon fiber etc.; metal powder or metal fiber such as copper, nickel, aluminum or silver; conductive polymer such as polyphenyl derivatives, or a mixture comprising two or more of the above.

The method for preparing the anode is as follows, first, providing a cleaned current collector; then, mixing the second carbon material and the second binder with a solvent to form a uniform carbon intermediate mixture; then, mixing the porous carbon material and the first binder with a solvent to form an anode active material mixture; next, coating the carbon intermediate mixture onto the current collector to form the carbon intermediate layer; and then, coating the anode active material mixture onto the carbon intermediate layer to form the anode active material layer. The solvent is preferably N-methylpyrrolidone, abbr. as NMP.

The present disclosure also provides a lithium ion battery which includes the anode described above. To be more specific, the lithium ion battery includes an anode, a cathode, a separator and an electrolyte, the separator is sandwiched between the anode and the cathode; and the anode, the cathode and the separator are immersed in the electrolyte.

Anode: The anode is described in detail above.

Cathode:

The cathode of the lithium ion battery includes a current collector and a cathode active material layer coated on the current collector. The cathode active material layer includes a cathode active material and a binder. The cathode active material is mixed uniformly within the binder, and the binder causes adhesion to the cathode active materials and also causes adhesion between the cathode active material and the current collector. In one embodiment, a material of the current collector is aluminum. In another embodiment, the cathode active material is selected from at least one of the following or another similar material: lithium cobalt oxide (LiCoO₂, abbr. as LCO), lithium manganate (LiMn₂O₄, abbr. as LMO), lithium nickel cobalt manganate (LiNi_{1-x-y}CoₓMn_{y}O₂, abbr. as NCM), lithium nickel cobalt aluminum oxide (NCA), lithium iron phosphate (LFP), lithium manganese iron phosphate (LiMn_{0.6}Fe_{0.4}PO₄, abbr. as LMFP).

The binder of the cathode functions to cause the particles of the cathode active material to adhere together and to make the cathode active material layer bond to the current collector. In one embodiment, the binder is made of a material selected from but not limited to the following: polyvinyl alcohol (PVA), carboxymethyl cellulose (CMC), hydroxypropyl cellulose (HPC), diacetyl cellulose, polyvinyl chloride (PVC), carboxylic polyvinyl chloride, polyvinyl fluoride (PVF), ethylene oxide polymer, polyvinylpyrrolidone (PVP), polyurethane (PU), polytetrafluoroethylene (PTFE), polyvinylidene fluoride (PVDF), polyethylene (PE), polypropylene (PP), styrene-butadiene rubber (SBR), acrylate butadiene rubber, epoxy resin, or nylon, etc.

Optionally, the cathode active material layer further can include a conductive material, which is mixed uniformly in the cathode active material layer. The conductive material of the cathode functions to endow the cathode with conductivity. Any conductive material which does not cause chemical change can be used as the conductive material of the invention. In one embodiment, the conductive material is selected from the following: carbonaceous materials such as natural graphite, artificial graphite, carbon black, acetylene black, conductive carbon black or carbon fiber etc.; metal powder or metal fiber such as copper, nickel, aluminum or silver; conductive polymer such as polyphenyl derivatives, or a mixture of the above.

The method for preparing the cathode includes the following steps: first, mixing the cathode active material, the binder, and the optional conductive material (if necessary) with a solvent, thereby preparing a cathode active material mixture; next, coating the cathode active material mixture onto the current collector of the cathode; and then drying to yield the cathode. The solvent is preferably N-methylpyrrolidone, abbr. as NMP.

Electrolyte:

The electrolyte of the battery includes a non-aqueous organic solvent and a lithium salt. The non-aqueous organic solvent functions as a medium to facilitate the movement of the ions participating in the electrochemical reaction. In one embodiment, the non-aqueous organic solvent is selected from the following: carbonate solvent, carbonate ester solvent, ester solvent, ether solvent, ketone solvent, alcohol solvent, and non-protonic solvent.

In one embodiment, the carbonate ester solvent is selected from but not limited to the following: dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), or butylenes carbonate (BC).

In another embodiment, the non-aqueous organic solvent is a mixture of chain carbonate compounds and cyclic carbonate compounds. The mixture above can improve the dielectric constant, and yield a low viscosity solvent. In still another embodiment, the volume ratio of the cyclic carbonate compounds to the chain carbonate compounds is 1:1 to 1:9.

In still another embodiment, the ester solvent is selected from but not limited to the following: methyl acetate, ethyl acetate, propyl acetate, vinyl acetate, methyl propionate, ethyl propionate, y-butyrolactone, decanolactone, valerolactone, mevalonolactone or caprolactone.

In yet another embodiment, the ether solvent is selected from but not limited to the following: dibutyl ether, tetraethylene glycol dimethyl ether, diethylene glycol dimethyl ether, ethylene glycol dimethyl ether, 2-methyltetrahydrofuran, tetrahydrofuran. In still another embodiment, the ketone solvent is cyclohexanone etc., and the alcohol solvent is ethanol, isopropanol, or another alcohol solvent.

The non-aqueous organic solvent above can be used alone or as a combination of the above. When at least two solvents are mixed together and acting as the non-aqueous organic solvent, the volume ratio of the components in the mixture can be adjusted according to the properties of the batteries.

Optionally, the non-aqueous organic solvent further includes an additive which aims to improve the security of the batteries. In one embodiment, the additive can be at least one of the following: phosphazene, phenylcyclohexane (CHB) or biphenyl (BP).

The lithium salt of the electrolyte is dissolved in the non-aqueous organic solvent and functions as a supply source of lithium ion in the lithium battery. It is a material which promotes the movement of lithium ions between the anode and the cathode, and makes it possible for the lithium secondary batteries to operate smoothly.

In one embodiment, the lithium salt is selected from the following: LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y-1}SO₂) (wherein x and y are both natural numbers), LiCl, LiI, LiB(C₂O₄)₂, or lithium bis(oxalate)borate (abbr. as LiBOB), or a combination of the above.

In another embodiment, the concentration of the lithium salt is between about 0.1M and about 2.0M. A lithium salt with such concentration above can endow the electrolyte with suitable conductivity and viscosity. Thus, the electrolyte facilitates the lithium ions to move effectively in it.

Separator:

The separator is used to separate the anode and the cathode, and provide a channel for the lithium ion to go through. It can be any conventional separator used in the lithium battery field. Further, materials which have low resistance and can easily absorb the electrolytes can be used as the separator. In one embodiment, the separator is selected from the following: glass fiber separator, polyester fiber separator, polyolefin separator, aramid separator or a combination of the above. The polyolefin separator above includes polyethylene (PE) separator, polypropylene (PP) separator, and polytetrafluoroethylene (PTFE, or Teflon) separator. In one embodiment, the separators of the batteries are normally made of a polyolefin such as polyethylene or polypropylene. In another embodiment, to ensure thermal resistance and mechanical strength, the separators can be coated with a ceramic component or polymers such as aramid fibers. In still another embodiment, the separator is in a form of nonwoven fabrics or woven fabrics. In yet another embodiment, the separator is in a monolayer or a multilayer structure.

In one embodiment, celluloses with high permeability are applied in the separator. In that case, the movement of the lithium ions is not restricted even at low temperatures where the viscosity of the electrolyte increases. Therefore, the application of the high permeable celluloses can increase the life-span of the separator at low temperatures.

Several embodiments are described below for purpose of illustration and description only. However, the descriptions are not intended to be exhaustive nor is the invention limited to the precise forms disclosed. For simplicity, the descriptions omit details which may be familiar to one with knowledge of the subject matter.

The porous carbon material acts as the frame of the anode, which is commercially available from Kureha Group or Kuraray Corporation in the present disclosure.

### Embodiment 1

Preparation of the anode, which includes the following steps: first providing a copper foil which has a thickness of 8 μm; second, mixing 96 wt % porous carbon material, 3 wt % styrene butadiene rubber (abbr. as SBR, acting as a binder) and 1 wt % CMC (Sodium salt of Caboxy Methyl Cellulose) uniformly to prepare an anode active material mixture, where the porosity of the porous carbon material is 10%, measured by a mercurial porosity meter and the active material of the porous carbon material has an electrical conductivity 10⁻¹ S/cm; third, coating the anode active material mixture onto the copper foil at a density of 3 mg/cm² to form an anode active material layer; and finally, after drying and rolling the anode active material layer, the anode is yielded. The density of the anode is 0.9 g/cc.

Preparation of the cathode: The steps are as follows: mixing 90 wt % of commercially available NCM (cathode active material) LiNi_{0.5}Co_{0.2}Mn_{0.3}O₂, 5 wt % of polyvinylidene fluoride and 5 wt % of acetylene black, dispersing the mixture in N-methylpyrrolidone (abbr. as NMP) to form slurry; then, spray-coating the slurry onto an aluminum foil, which has a thickness of 12 pm, wherein the coating density is 20 mg/cm²; and after drying at 100° C. and rolling, to yield the cathode. The density of the cathode is 3.0 g/cc.

Preparation of the battery: The steps are as follows: placing the anode and the cathode prepared above at the opposite, sandwiching a separator between the anode and the cathode, and winding them to form a jelly roll, inserting the jelly roll into a container, which is 18650 typed, i.e., a diameter of the container is 18 mm, and a length of the container is 65mm, injecting an electrolyte into the container to form a lithium ion battery A. The electrolyte above is prepared by dissolving LiPF₆ in a mixture of ethylene carbonate (EC) and methyl ethyl carbonate (MEC), wherein the concentration of LiPF₆ is 1.0M and the volume ratio of EC to MEC is 3:7. The separator is a porous polyethylene membrane.

### Embodiment 2

Embodiment 2 is similar to embodiment 1, and the differences are that the porous carbon material is pre-activated at 300° C. under air atmosphere for 30 minutes. After the treatment above, the porosity is changed to 40%, and the electrical conductivity of the active material therein is changed to 10⁻² S/cm. Other steps are the same as in embodiment 1, and yield a lithium ion battery B.

### Embodiment 3

Embodiment 3 is similar to embodiment 1, and the differences are that the porous carbon material is heat-treated for 30 minutes at an argon atmosphere of 1300° C. After the treatment above, the porosity is changed to 5%, and the electrical conductivity of the active material therein is changed to 10¹ S/cm. The other steps are the same as in embodiment 1, and yield a lithium ion battery C.

### Embodiment 4

Embodiment 4 is similar to embodiment 1, and the difference is that the carbon intermediate layer is applied in the embodiment. In this embodiment, the carbon intermediate layer is prepared by the following steps: mixing 95 wt % natural graphite and 5% PVDF to form a mixture, and then dispersing the mixture into NMP to prepare slurry, wherein a particle diameter of the natural graphite is 0.1-0.3 μm; next, providing a copper foil with a thickness of 8 μm, and coating the slurry onto both surfaces of the copper foil at a coating density of 0.2 mg/cm², drying at 100° C. and rolling to yield a carbon intermediate layer formed on the copper foil. The anode active material layer is coated on the carbon intermediate layer. Other steps are the same as in embodiment 1, and yield a lithium ion battery D.

### Embodiment 5

Embodiment 5 is similar to embodiment 1, and the difference is that: after rolling, the density of the anode is 0.55 g/cc. Other steps are the same as in embodiment 1, and yield a lithium ion battery E.

### Embodiment 6

Embodiment 6 is similar to embodiment 1, and the difference is that: during preparation of the battery, the separator is a porous aramid membrane. Other steps are the same as in embodiment 1, and yield a lithium ion battery F.

### Embodiment 7

Embodiment 7 is similar to embodiment 1, and the difference is that: during preparation of the battery, 10% phosphazene (an additive agent) with a fire point over 100° C. is further added into the electrolyte. Other steps are the same as in embodiment 1, and yield a lithium ion battery G.

### Comparative Example 1

Comparative example 1 is similar to embodiment 1, and the difference is that: the porous carbon material used in embodiment 1 is replaced by commercial available natural graphite in comparative example 1, wherein the porosity of the natural graphite is 1% and its active powder has an electrical conductivity of 10² S/cm. Other steps are the same as in embodiment 1, and yield a lithium ion battery H.

### Comparative Example 2

Comparative example 2 is similar to embodiment 1, and the difference is that: the porous carbon material is pre-activated at 300° C. under air atmosphere for 5 hours. After the treatment above, the porosity is changed to 60%, and the electrical conductivity of the active material therein is changed to 10⁻³ S/cm. Other steps are the same as in embodiment 1, and yield a lithium ion battery I.

### Comparative Example 3

Comparative example 3 is similar to embodiment 1, and the difference is that: after rolling, the density of the coated anode is changed to 1.15 g/cc. Other steps are the same as in embodiment 1, and yield a lithium ion battery J.

### Comparative Example 4

Comparative example 4 is similar to embodiment 1, and the difference is that: after rolling, the density of the coated anode is changed to 0.4 g/cc. Other steps are the same as in embodiment 1, and yield a lithium ion battery K.

Battery Characteristics Evaluation

Charging the lithium secondary batteries A-K prepared by Embodiments 1-7 and Comparative examples 1-4 at a constant current of 1.0 A, until their voltages reach 4.2V. Then, discharging the batteries at a constant current of 1.0 A until their voltages reach 2.5V. The discharge capacity herein is taken as an initial capacity. Meanwhile, charging the batteries at a constant current of 1.0 A until the voltage reaches 4.2V, and discharging at a constant current of 1.0 A until the voltage reaches 2.5V. After repeating the charging and discharging above for 500 cycles, a discharging capacity after 500 cycles is obtained. A ratio of the initial capacity to the discharging capacity after 500 cycles is named as capacity retention, which is used to evaluate the life-span characteristic of batteries.

Further, after evaluating the life-span as described above, charging the batteries at a constant current of 0.5 A until its voltage reaches 4.2V. And then, placing the batteries into a heat-resistant and anti-explosion constant-temperature bath, raising the temperature with a rate of 5 V/min to measure the self-heating of the batteries, and further evaluating the thermal stability of the batteries.

TABLE 1
battery characteristics

| | | | | Anode | | | | | | Thermal |
|---|---|---|---|---|---|---|---|---|---|---|
| | | | Electrical | Electrode | Carbon | | | Initial | Capacity | Runaway |
| | | Porosity | conductivity | density | intermediate | | Additive | Capacity | Retention | Temperature |
| | Batteries | (%) | (S/cm) | (g/cc) | layer | Separator | agent | (mAh) | (%) | (° C.) |
| Embodiment 1 | A | 10 | 10⁻¹ | 0.9 | — | PE | — | 2980 | 82 | 173 |
| Embodiment 2 | B | 40 | 10⁻² | 0.7 | — | PE | — | 2821 | 88 | 170 |
| Embodiment 3 | C | 5 | 10¹ | 0.95 | — | PE | — | 3013 | 76 | 177 |
| Embodiment 4 | D | 10 | 10⁻¹ | 0.9 | ✓ | PE | — | 3005 | 92 | 172 |
| Embodiment 5 | E | 10 | 10⁻¹ | 0.55 | — | PE | — | 2835 | 90 | 180 |
| Embodiment 6 | F | 10 | 10⁻¹ | 0.9 | — | Aramid | — | 2962 | 85 | 205 |
| Embodiment 7 | G | 10 | 10⁻¹ | 0.9 | — | Aramid | phosphazene | 2983 | 83 | 220 |
| Comparative | H | 1 | 10² | 1.2 | — | PE | — | 2381 | 16 | 130 |
| example 1 | | | | | | | | | | |
| Comparative | I | 60 | 10⁻³ | 0.6 | — | PE | — | 2268 | 75 | 155 |
| example 2 | | | | | | | | | | |
| Comparative | J | 10 | 10⁻¹ | 1.15 | — | PE | — | 3067 | 27 | 178 |
| example 3 | | | | | | | | | | |
| Comparative | K | 10 | 10⁻¹ | 0.4 | — | PE | — | 2368 | 76 | 159 |
| example 4 | | | | | | | | | | |

Table 1 shows the characteristics of batteries A-K. As described above, porous carbons in Embodiments 1-7 function as the frame of lithium precipitation, wherein the porosity and electrical conductivity of the porous carbons are in suitable range. Further, the density of the anodes prepared in embodiments 1-7 are also in a suitable range. In contrast, particular treated porous carbon materials are applied in comparative examples 1-2, and anodes with a density deviate from suitable range are applied in comparative examples 3-4. The comparison between embodiments 1-7 and comparative examples 1-4 shows that the batteries prepared by the method of the present disclosure have higher capacity, longer life-span and better thermal stability after 500 cycles than the comparative examples do.

The above shows that in the batteries described in the present disclosure, when lithium metal is detached in the anode, expansion/contraction of the anode is reduced by the porous carbon material of the anode, which benefits the batteries. Further, in the presence of the porous carbon material on the current collector of the anode, during charging, small lithium particles or lithium dendrites would never form on the anode surface, and as a result, the battery capacity would never decrease. Because of the above, the batteries as described in the present disclosure have higher capacity, higher energy density and longer life-span.

It should be noted that the above particular embodiments are shown and described by way of illustration only. The above-described embodiments illustrate the scope of the disclosure but do not restrict the scope of the disclosure. The principles and the features of the present disclosure may be employed in various and numerous embodiments without departing from the scope of the disclosure.

What is claimed is:

1. An anode, comprising a current collector and an anode material stack coated on the current collector, wherein the anode material stack comprises an anode active material layer, the anode active material layer comprises porous carbon material and a first binder, and the porous carbon material is mixed with the binder.

2. The anode of claim 1, wherein the first binder is selected from the following:
polyvinyl alcohol, carboxymethyl cellulose, hydroxypropyl cellulose, polyvinyl chloride, carboxylic polyvinyl chloride, polyvinyl fluoride, ethylene oxide polymer, polyvinylpyrrolidone, polyurethane, polytetrafluoroethylene, polyvinylidene fluoride, polyethylene, polypropylene, styrene-butadiene rubber, acrylate butadiene rubber, epoxy resin or nylon.

3. The anode of claim 1, wherein the porous carbon material is amorphous structured, and comprises a plurality of meso-pores and micro-pores, a pore diameter of the meso-pores is 2-50 nm, and that of the micro-pores is less than 2 nm.

4. The anode of claim 1, wherein the porous carbon material is hard carbon dotted with pores, and a volume of the pores accounts for 20%-50% of the whole volume thereof; or the porous carbon material is a soft carbon synthesized by pitches.

5. The anode of claim 1, wherein the porous carbon material is selected from carbon black, charcoal, coke, bone black, sugar charcoal, activated carbon and cellulose carbon.

6. The anode of claim 1, wherein a porosity of the porous carbon material is in a range from 5% to 50%.

7. The anode of claim 1, wherein the porous carbon material is in a form of active powders, and an electrical conductivity thereof is in a range from 10⁻² S/cm to 10³ S/cm.

8. The anode of claim 1, wherein the anode material stack further comprises a carbon intermediate layer, the carbon intermediate layer is sandwiched between the current collector and the anode active material layer, the carbon intermediate layer comprises a second carbon material and a second binder, the second carbon material is mixed with the second binder.

9. The anode of claim 8, wherein a material of the second binder is different from that of the first binder.

10. The anode of claim 8, wherein the second binder is selected from a group consisting of but not limited to the following: polyvinyl alcohol, carboxymethyl cellulose, hydroxypropyl cellulose, polyvinyl chloride, carboxylic polyvinyl chloride, polyvinyl fluoride, ethylene oxide polymer, polyvinylpyrrolidone, polyurethane, polytetrafluoroethylene, polyvinylidene fluoride, polyethylene, polypropylene, styrene-butadiene rubber, acrylate butadiene rubber, epoxy resin or nylon.

11. The anode of claim 8, wherein the carbon intermediate layer is made of conductive carbon material, and an electrical conductivity of the conductive carbon material is higher than that of the porous carbon material.

12. The anode of claim 11, wherein the conductive carbon material is carbon black or graphite.

13. The anode of claim 8, wherein the anode active material layer and/or the carbon intermediate layer further comprises a conductive material therein, which is selected from the following: natural graphite, artificial graphite, carbon black, acetylene black, conductive carbon black, carbon fiber; metal powder or metal fiber of copper, nickel, aluminum or silver; polyphenyl derivatives, or a mixture of the above.

14. The anode of claim 8, wherein the anode material stack has a density at a range from 0.5 g/cc to 1.0 g/cc.

15. A method for preparing the anode of claim 1, comprising the steps:
providing a current collector;
mixing a porous carbon material and a first binder with a solvent to form an anode active material mixture;
coating the anode active material mixture onto the current collector to form an anode active material layer; and
drying and rolling to yield the anode.

16. The method for preparing an anode of claim 15, further comprising the following steps:
mixing a second carbon material and a second binder with a solvent to form a carbon intermediate mixture;
before coating the anode active material mixture, coating the carbon intermediate mixture onto the current collector to form the carbon intermediate layer; and
coating the anode active material mixture onto the carbon intermediate layer.

17. A lithium ion battery, comprising an anode, a cathode, a separator sandwiched between the anode and the cathode, and an electrolyte, wherein the anode is described in claim 1.

18. The lithium ion battery of claim 17, wherein the cathode comprising a current collector and a cathode active material layer coated on the current collector, which comprises a cathode active material, a binder and optional conductive material.

19. The lithium ion battery of claim 18, wherein the cathode active material comprising at least one of the following: lithium cobalt oxide, lithium manganate, lithium nickel cobalt manganate, lithium nickel cobalt aluminum oxide, lithium iron phosphate, and lithium manganese iron phosphate.

20. The lithium ion battery of claim 18, wherein the conductive material is selected from the following: natural graphite, artificial graphite, carbon black, acetylene black, conductive carbon black or carbon fiber; metal powder or metal fiber of copper, nickel, aluminum or silver; polyphenyl derivatives, or a mixture thereof.
